(19) United States
(12) Patent Application Publication
(10) Pub. No.: US 2013/0019057 A1
(43) Pub. Date: Jan. 17, 2013

(54) FLASH DISK ARRAY AND CONTROLLER

(71) Applicant: Donpaul C. Stephens, Princeton, NJ (US)

(72) Inventor: Donpaul C. Stephens, Princeton, NJ (US)

(73) Assignee: Violin Memory, Inc., Mountain View, CA (US)

(21) Appl. No.: 13/546,179

(22) Filed: Jul. 11, 2012

Related U.S. Application Data
(60) Provisional application No. 61/508,177, filed on Jul. 15, 2011.

(51) Int. Cl. G06F 12/00

(52) U.S. Cl. 711/103; 711/E12.008

(57) ABSTRACT

A data storage array is described, having a plurality of solid state disks configured as a RAID group. User data is mapped and managed on a page size scale by the controller, and the data is mapped on a block size scale by the solid state disk. The writing of data to the solid state disks of the RAID group is such that reading of data sufficient to reconstruct a RAID stripe is not inhibited by the erase operation of a disk to which data is being written.

This application claims the benefit of priority to U.S. provisional application No. 61/508,177, filed on Jul. 15, 2011, which is incorporated herein by reference.

### TECHNICAL FIELD

This application relates to the storage of digital data in non-volatile media.

### BACKGROUND

The data or program storage capacity of a computing system may be organized in a tiered fashion, to take advantage of the performance and economic attributes of the various storage technologies that are in current use. The balance between the various storage technologies evolves with time due to the interaction of the performance and economic factors.

Apart from volatile semiconductor memory (such as SRAM) associated with the processor as cache memory, volatile semiconductor memory (such as DRAM) may be provided for temporary storage of active programs and data being processed by such programs. The further tiers of memory tend to be much slower, such as rotating magnetic media (disks) and magnetic tape. However, the amount of DRAM that is associated with a processor is often insufficient to service the actual computing tasks to be performed and the data or programs may need to be retrieved from disk. This process is a well known bottleneck in data base systems and related applications. However, it is also a bottleneck in the ordinary personal computer, although the cost implications of a solution have muted user complaints in this application. At this juncture, magnetic tape systems are usually relegated to performing back-up of the data on the disks.

More recently, an evolution of EEPROM (electrical erasable programmable read only memory) has occurred that is usually called FLASH memory. This memory type may be characterized as being a solid-state memory having the ability to retain data written to the memory for a significant time after the power has been removed. In this sense a FLASH memory may have the permanence of a disk or a tape memory. As a solid state device, the memory may be organized so that the sequential access aspects of magnetic tape, or the rotational latency of a disk system may, in part, be obviated.

Two generic types of FLASH memory are in current production: NOR and NAND. The latter has become favored for the storage of large quantities of data and has led to the introduction of memory modules that emulate industry standard disk interface protocols while having lower latency for reading and writing data. These products may even be packaged in the same form factor and with the same connector interfaces as the hard disks that they are intended to replace. Such disk emulation solid-state memories may also use the same software protocols, such as ATA. However, a variety of physical formats and interface protocols are available and include those compatible with use in laptop computers, compact flash (CF), SD and others.

While the introduction of FLASH based memory modules (often termed SSD, solid state disks, or solid state devices) has led to some improvement in the performance of systems, ranging from personal computers, data base systems and to other networked systems, some of the attributes of the NAND FLASH technology impose performance limitations. In particular, FLASH memory has limitations on the method of writing data to the memory and on the lifetime of the memory, which need to be taken into account in the design of products.

A FLASH memory circuit, which may be called a die, or chip, may be comprised of a number of blocks of data (e.g., 128 KB of per block) with each block organized as a plurality of contiguous pages (e.g., 4 KB per page). So 32 pages of 4 KB each would comprise a physical memory block. Depending on the product, the number of pages, and the sizes of the pages may differ. Analogous to a disk, a page may be comprised of number of sectors (e.g., 8×512 B per page).

The size of blocks, pages and sectors is characteristic of a specific memory circuit design, and may differ and change in size as the technology evolves, or with products from a different manufacturer. So, herein, the terms, page and sector are considered to represent a data structures when used in a logical sense, and (physical) page and (memory block) block to represent the places in which the data is stored in a physical sense. The term logical block address (LBA) may be confusing, as it may represent a logical identification of a sector or a page of data, and is not the equivalent of a physical block of data which has a size of a plurality of pages.. So as to avoid introducing further new terminology, this lack of congruence between the logical and physical terminology is noted, but nevertheless adopted for this specification. A person of skill in the art would understand the meaning in the context in which these words are used.

A particular characteristic of FLASH memory is that, effectively, the pages of a physical block can be written to once only, with an intervening operation to reset (“erase”) the pages of the (physical) block before another write (“program”) operation to the block can be performed. Moreover, the pages of an integral block of FLASH memory are erased as a group, where the block may be comprised of a plurality of pages. Another consequence of the current device architecture is that the pages of a physical memory block are expected to be written to in sequential order. The writing of data may be distinguished from the reading of data, where individual pages may be addressed and the data read out in a random-access fashion analogous to, for example, DRAM.

In another aspect, the time to write data to a page of memory is typically significantly longer than the time to read data from a page of memory, and during the time that the data is being written to a page, read access to the block or the chip is inhibited. The time to erase a block of memory takes even longer than the time to write a page (though less than the time to write data to all of the pages in the block in sequence), and read the data stored in other blocks of a chip may be prevented during the erase operation. Page write times are typically 5 to 20 times longer than page read times. Block erases are typically ˜5 times longer than page write times; however, as the erase operation may be amortized over the ˜32 to 256 pages in a typical block, the erase operation consumes typically under 5% of the total time for erasing and writing an entire block. Yet, when an erase operation is encountered, a significant short-term excess read latency occurs. That is the time to respond to a read request is in excess of the specified performance of the memory circuit.

FLASH memory circuits have a wear-out characteristic that may be specified as the number of erase operations that may be performed on a physical memory block before some of the pages of the physical memory block (PMB) become unreliable and the errors in the data being read can no longer can be corrected by the extensive error correcting codes (ECC) that are commonly used. Commercially available components that are single-level-cell (SLC) circuits, capable of storing one bit per cell, have an operating lifetime of about 100,000 erasures and multi-level-cell (MLC) circuits, capable of storing two bits per cell, have an operating lifetime of about 10,000 erasures. It is expected that the operating lifetime may decline when the circuits are manufactured on finer-grain process geometries and when more bits of data are stored per cell. These performance trends are driven by the desire to reduce the cost of the storage devices.

A variety of approaches have been developed so as to mitigate at least some of the characteristics of the FLASH memory circuits that may be undesirable, or which limit system performance. A broad term for these approaches is the “Flash Translation Layer” (FTL). Generically, such approaches may include logical-to-physical address mapping, garbage collection and wear leveling.

Logical-to-physical address (L2P) mapping is performed to overcome the limitation that a physical memory address can be written to only once before being erased, and also the problems of “hot spots” where a particular logical address is the subject of significant activity, particularly the modification of data. Without logical-to-physical address translation, when a page of data is read, and data on that page is modified, the data cannot be stored again at the same physical address without an erase operation having first been performed at that physical location. Such writing-in-place would require the entire block of pages, including the page to be written to or modified, be temporarily stored, the corresponding memory block erased, and all of the temporarily stored data of the block, including the modified data, be rewritten to the erased memory block. Apart from the time penalty, the wear due to erase activity would be excessive.

An aspect of the FTL is a mapping where a logical address of the data to be written is mapped to a physical memory address meeting the requirements for sequential writing of data to the free pages (previously erased pages not as yet written to) of a physical memory block. Where data of a logical address is being modified, the data is then stored at the newly mapped physical address and the physical memory location where the invalid data was stored may be marked in the FTL metadata as invalid data. Any subsequent read operation is directed to the new physical memory storage location where the modified data has been stored. Ultimately, all of the physical memory blocks of the FLASH memory would be filled with new or modified data, yet many of the physical pages of memory, scattered over the various physical blocks of the memory would have been marked as having invalid data, as the data stored therein, having been modified, has been written to another location. At this juncture, there would be no more physical memory locations to which new or modified data could be written. The FTL operations performed to prevent this occurrence are termed “garbage collection.” The process of “wear leveling” may be performed as part of the garbage collection process, or separately.

Garbage collection is the process of reclaiming physical memory blocks having invalid data pages (and which may also have valid data pages whose data needs to be preserved) so as to result in one or more such physical memory blocks that can be entirely erased, so as to be capable of accepting new or modified data. In essence, this process consolidates the still-valid data of a plurality of physical memory blocks by, for example, moving the valid data into a previously erased (or never used) block by sequential writing thereto, remapping the logical-to-physical location and marking the originating physical memory page as having invalid data, so as to render the physical memory blocks that are available to be erased as being comprised entirely of invalid data. Such blocks may also have some free pages where data has not been written since the last erasure of the block. The blocks may then be erased. Wear leveling may often be a part of the garbage collection process, using, for example, a criterion that the least-often-erased of the erased blocks that are available for writing of data are selected for use when an erased block is used by the FTL. Effectively, this action may even out the number of times that blocks of the memory circuit are erased over a period of time. In another aspect, the least erased of a plurality of blocks currently being used to store data may be selected when a block needs to be erased. Other wear management and lifetime-related methods may be used.

This discussion has been simplified so as to form a basis for understanding the specification and does not cover the complete scope of activities associated with reading and writing data to a FLASH memory, including error detection and correction, bad block detection, and the like.

The concept of RAID (Redundant Arrays of Independent (or Inexpensive) Disks) dates back at least as far as a paper written by David Patterson, Garth Gibson and Randy H. Katz in 1988. RAID allows disk memory systems to be arranged so to protect against the loss of the data that they contain by adding redundancy. In a properly configured RAIDed storage architecture, the failure of any single disk, for example, will not interfere with the ability to access or reconstruct the stored data. The Mean Time Between Failure (MTBF) of the disk array without RAID would be equal to the MTBF of an individual drive, divided by the number of drives in the array, since the loss of any disk results in a loss of data. Because of this, the MTBF of an array of disk drives would be too low for many application requirements. However, disk arrays can be made fault-tolerant by redundantly storing information in various ways. So, RAID prevents data loss due to a failed disk, and a failed disk can be replaced and the data reconstructed. That is, conventional RAID is intended to protect against the loss of stored data arising from a failure of a disk of an array of disks.

RAID-3, RAID-4, RAID-5, and RAID-6, for example, are variations on a theme. The theme is parity-based RAID. Instead of keeping a full duplicate (“mirrored”) copy of the data as in RAID-1, the data itself is spread over several disks with an additional disk(s) added. The data on the additional disk may be calculated (using Boolean XORs) based on the data on the other disks. If any single disk in the set of disks containing the data that was spread over a plurality of disks is lost, the data stored on a disk that has failed can be recovered through calculations performed using the data on the remaining disks. RAID-6 has multiple dispersed parity bits and can recover data after a loss of two disks. These implementations are less expensive than RAID-1 because they do not require the 100% disk space overhead that RAID-1 requires for mirroring the data. However, because some of the data on the disks is calculated, there are performance implications associated with writing and modifying data, and recovering data after a disk is lost. Many commercial implementations of parity RAID use cache memory to alleviate some of the performance issues.

Note that the term RAID 0 is sometimes used in the literature; however, as there is no redundancy in the arrangement, the data is not protected from loss in the event of the failure of the disk.

Fundamental to RAID is “striping”, a method of concatenating multiple drives (memory units) into one logical storage unit (a RAID group). Striping involves partitioning storage space of each drive of a RAID group into “strips” (also called “sub-blocks”, or “chunks”). These strips are then arranged so that the combined storage space for the data is comprised of strips from each drive in the stripe for a logical block of data, which is protected by the corresponding strip of parity data. The type of application environment, I/O or data intensive, may be a design consideration that determines whether large or small strips are used.

Since the terms “block,” “page” and “sector” may have different meanings in differing contexts, this discussion will attempt to distinguish between them when used in a logical sense and in a physical sense. In this context, the smallest group of physical memory locations that can be erased at one time is a “physical memory block” (PMB). The PMB is comprised of a plurality of “physical memory pages” (PMP), each PMP having a “physical memory address” (PMA) and such pages may be used to store user data, error correction code (ECC) data, metadata, or the like. Metadata, including ECC, is stored in extra memory locations of the page provided in the FLASH memory architecture for “auxiliary data”. The auxiliary data is presumed to managed along with the associated user data. The PMP may have a size, in bytes, PS, equal to that of a logical page, which may have an associated logical block address (LBA). For example, a PMP may be capable of storing nominally a logical page of 4 Kbytes of data, and a PMB may comprise 32 PMP. A correspondence between the logical addresses and the physical location of the stored data is maintained through data structures such a logical-to-physical (L2P) address table. The relationship is termed a “mapping”. In a FLASH memory system this and other data management functions are incorporated in a “Flash Translation Layer (FTL).”

When the data is read from a memory, the integrity of the data may be verified by the associated ECC data of the metadata and, depending on the ECC employed, one or more errors may be detected and corrected. In general, the detection and correction of multiple errors is a function of the ECC, and the selection of the ECC will depend on the level of data integrity required, the processing time, and other costs. That is, each “disk” is assumed to detect and correct errors arising thereon and to report uncorrectable errors at the device interface. In effect, the disk either returns the correct requested data, or reports an error.

A class of product termed a “Solid State Disk” (SSD) has come on the commercial market. This term is not unambiguous, and some usage has arisen where any memory circuit that is comprised of non-rotating-media non-volatile storage is termed as SSD. Herein, a SSD is considered to be a predominantly non-volatile memory circuit that is embodied in a solid-state device, such as FLASH memory, or other functionally similar solid-state circuit that is being developed, or which is subsequently developed, and has similar performance objectives. The SSD may include a quantity of volatile memory for use as a data buffer, cache or the like, and the SSD may be designed so that, in the event of a power loss, there is sufficient stored energy on circuit card or in an associated power source so as to commit the data in the volatile memory to the non-volatile memory. Alternatively, the SSD may be capable of recovering from the loss of the volatile data using a log file, small backup disk, or the like. The stored energy may be from a small battery, supercapacitor, or similar device. Alternatively, the stored energy may come from the device to which the SSD is attached such as a computer or equipment frame, and commands issued so as to configure the SSD for a clean shutdown. A variety of physical, electrical and software interface protocols have been used and others are being developed and standardized. However, special purpose interfaces are also used.

In an aspect, SSDs are often intended to replace conventional rotating media (hard disks) in applications ranging from personal media devices (iPods & smart phones), to personal computers, to large data centers, or the Internet cloud. In some applications, the SSD is considered to be a form, fit and function replacement for a hard disk. Such hard disks have become standardized over a period of years, particularly as to form factor, connector and electrical interfaces, and protocol, so that they may be used interchangeably in many applications. Some of the SSDs are intended to be fully compatible with replacing a hard disk. Historically, the disk trend has been to larger storage capacities, lower latency, and lower cost. SSDs particularly address the shortcoming of rotational latency in hard disks, and are now becoming available from a significant number of suppliers.

While providing a convenient upgrade path for existing systems, whether they be personal computers, or large data centers, the legacy interface protocols and other operating modalities used by SSDs may not enable the full performance potential of the underlying storage media.

### SUMMARY

A data storage system is disclosed, including a plurality of memory modules, each memory module having a plurality of memory blocks, and a first controller configured to execute a mapping between a logical address of data received from a second controller and a physical address of a selected memory block. The second controller is configured to interface with a group of memory modules of the plurality of memory modules, each group comprising a RAID group and to execute a mapping between a logical address of user data and a logical address of each of each of the memory modules of the group of memory modules of the RAID group such that user data is written to the selected memory block of each memory module.

In an aspect the memory blocks are comprised of a non-volatile memory, which may be NAND FLASH circuits.

A method of storing data is disclosed, including: providing a memory system having a plurality of memory modules; selecting a group of memory modules of the group of memory modules to comprise a RAID group; and providing a RAID controller.

Data is received by the memory system from a user and processed for storage in a RAID group of the memory system by mapping a logical address of a received page of user data to a logical address space of each of the memory modules of a RAID group. A block of memory of each of the memory modules that has previously been erased is selected and the logical address space of each of the memory modules is mapped to the physical address space in the selected block of each memory module. The mapped user data is written to the mapped block of each memory module until the block is filled, before mapping data to another memory block.

### BRIEF DESCRIPTION OF THE DRAWINGS

FIG. 1 is a block diagram of a computing system having a memory system;

FIG. 2 is a block diagram of a memory controller of the memory system;

FIG. 3 is a block diagram of memory modules configured as a RAID array;

FIG. 4 is a block diagram of a controller of a memory module;

FIG. 5 is a timing diagram showing the sequence of read and write or erase operations for a RAID group;

FIG. 6A shows a first example of the filling of the blocks of a chip;

FIG. 6B shows a second example of the filling of the blocks of a chip;

FIG. 7 is a flow diagram of the process for managing the writing of data to a block of a chip;

FIG. 8 shows an example of a sequence of writing operations to the memory modules of a RAID group;

FIG. 9 shows another example of a sequence of writing operations to the memory modules of a RAID group; and

FIG. 10 is a flow diagram of the process of writing blocks of a stripe of a RAID group to memory modules of a RAID group.

### DESCRIPTION

Exemplary embodiments may be better understood with reference to the drawings, but these examples are not intended to be of a limiting nature. Like numbered elements in the same or different drawings perform equivalent functions. Elements may be either numbered or designated by acronyms, or both, and the choice between the representation is made merely for clarity, so that an element designated by a numeral, and the same element designated by an acronym or alphanumeric indicator should not be distinguished on that basis.

When describing a particular example, the example may include a particular feature, structure, or characteristic, but every example may not necessarily include the particular feature, structure or characteristic. This should not be taken as a suggestion or implication that the features, structure or characteristics of two or more examples should not or could not be combined, except when such a combination is explicitly excluded. When a particular feature, structure, or characteristic is described in connection with an example, a person skilled in the art may give effect to such feature, structure or characteristic in connection with other examples, whether or not explicitly described.

When groups of SSDs are used to store data, a RAIDed architecture may be configured so as to protect the data being stored from the failure of any single SSD, or portion thereof. In more complex RAID architectures (such as dual parity), the failure of more than one module can be tolerated. But, the properties of the legacy interfaces (for example, serial ATA (SATA) in conjunction with the Flash Translation Layer (FTL) often results in compromised performance. In particular, when garbage collection (including erase operations) is being performed on a PMB of an SSD, the process of reading of a page of data from the SSD is often inhibited, or blocked, for a significant period of time due to erase or write operations. This blockage can be, for example, perhaps, greater than 40 msec, whereas it would have been expected that reading of the page of data would have taken only about 500 μsec. When the page of data is part of the data of a RAID group, the reading a stripe of a RAID group could take at least 40 msec, rather than about 500 μsec. These “latency glitches” may have a significant impact of the performance of an associated data base system. So, while SSDs may improve performance, the use of an SSD does not obviate the issue of latency.

In an aspect, each SSD, when put in service for the first time, has a specific number of physical memory blocks PMB that are serviceable and are allocated to the external user. In this initial state, a contiguous block of logical space at the interface to the SSD (a 128 KB range, for example) may be associated with (mapped to) a physical memory block (PMB) of the same storage capacity. While the initial association of LBAs to a PMB is unique at this juncture, the PMBs may not necessarily be contiguous. The association of the logical and physical addresses is mediated by a FTL.

Let us assume that the memory of the SSD that has been allocated for user data has been filled by writing data sequentially to LBAs which are mapped to the actual physical storage locations by the FTL of the SSD. After 32 LBAs of 4 KB size have been written to sequential PMPs of a block of the SSD, a first block of the plurality of PMB has been filled with 128 KB of data. The FTL then allocates a second available PMB to the next 32 LBAs to be written, and so on until a specified number of PMBs has been fully written with sequential PMP data. The remaining PMBs in the SSD may be considered as either spare blocks (erased and ready for writing), bad blocks, or used for system data, metadata, or the like.

Let us assume the next operation to be performed is a modify operation in which previously stored data is read from a memory location corresponding to a previously written user LBA and is modified by the using program, and that the modified data of the LBA is intended to be stored again at the same LBA. The FTL marks the PMA of the previously associated PMP of the PMB for the data being modified as being invalid (since the data has been modified), and attempts to allocate a new PMP to the modified data so that it can be stored. But, there may now be no free space in the local PMB and the data may need to be written to another block having free PMPs. This may be a block selected from a pool of erased or spare blocks. That is, a pool of memory blocks may be maintained in an erased state so that they may be immediately written with data. So, after having perhaps only one of the PMPs of a PMB of the SSD being marked as invalid, the SSD may now be “full” and a spare block needs to be used to receive and store the modified data. In order to maintain the pool of spare blocks, a PMB having both valid and invalid data may be garbage collected so that it may be erased. That is, the valid data is moved to another physical memory block so that all of the original memory block may be erased without data loss.

Now, in the ordinary course of events, there would have already been a number of instances where the data stored in the SSD would have been read from individual PMPs, modified by a using program, and again stored in the PMPs of PMBs of the SSD. So, at the time that the predetermined number of PMBs of the SSD have been filled (either with data or marked as invalid), at least one of the PMBs will have a quantity of PMPs (but not necessarily all) marked as invalid. The PMB having the largest number of invalid PMPs could be selected, for example, for garbage collection. All of the valid data could then be moved to a spare block, or to fill the remaining space in a partially written block, with the locations determined by the FTL. After these moves are completed, valid data will have been moved from the source block. The source block can now be erased and declared a “spare” block, while the free PMPs on the destination block can be used for modified or moved data from other locations. Wear leveling may be accomplished, for example, by selecting spare blocks to be used in accordance with a policy where the spare block that has the least number of erasures would be used as the next block to be written.

The FTL may be configured such that any write operation to an LBA is allocated a free PMP, typically in sequential order within a PMB. When the source of the data that has been modified was the previously stored data (same logical address) LBA, the associated source PMP is marked as invalid. But, the PMP where the modified data of the LBA is stored is allocated within a PMB in sequential order, whereas the data that is being modified may be read in a random pattern. So, after a time, the association of the user LBA at the SSD interface with the PMP where the data is stored is obscured by the operation of the FTL. As such, whether a particular write operation fills a PMB, and may trigger a garbage collection operation is not readily determinable a priori. So, the garbage collection operations may appear to initiate randomly and cause “latency spikes” as the SSD will be “busy” during garbage collection or erase operations.

An attribute of a flash transition layer (FTL) is the mapping of a logical block address (LBA) to the actual location of the data in memory: the address of physical page (PMA). Generally, one would understand that the “address” would be the base address of a defined range of data starting at the LBA or corresponding PMA. The PMA may coincide with, for example, a sector, a page or a block of FLASH memory. In this discussion, let us assume that it is associated with a page of FLASH memory.

When a FLASH SSD is placed into service, or formatted, there may be no stored user data. The SSD may have a listing of bad blocks or pages provided by the manufacturer, and obtained during the factory testing of the device. Such bad areas are excluded from the space that may be used for storage of data and are not seen by a user. The FTL takes the information into account, as well as any additional bad blocks that are found during formatting or operation.

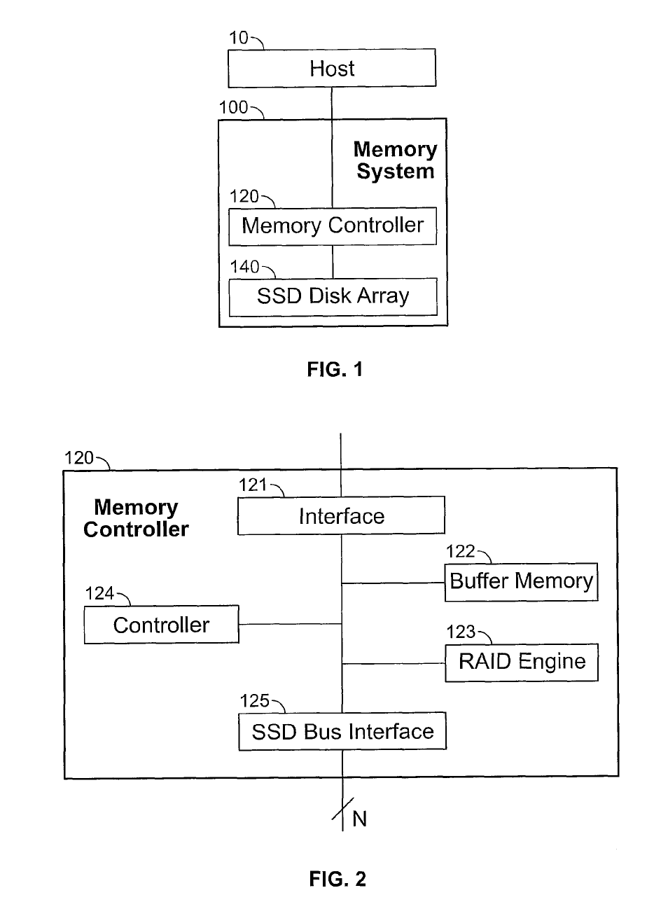

FIG. 1 shows a simplified block diagram of a memory system 100 using a plurality of SSD-type modules The memory system 100 has a memory controller 120 and a memory array 140, which may be a FLASH memory disk-equivalent (SSD), or similar memory module devices. As shown in FIG. 2, the memory controller 120 of the memory system communicates with the user environment, shown as a “host” 10 in FIG. 1, through an interface 121, which may be an industry standard interface such as PCIe, SATA, SCSI, or other interface, which may be a special purpose interface.

The memory controller 120 may also have its own controller 124 for managing the overall activity of the memory system 110, or the controller function may be combined with the computational elements of a RAID engine 123, whose function will be further described. A buffer memory 122 may be provided so as to efficiently route data and commands to and from the memory system 110, and may be provided with a non-volatile memory area to which transient data or cached data may be stored. A source of temporary back-up power may be provided, such as a supercapacitor or battery (not shown). An interface 125 to the SSDs, which may comprise the non-volatile memory of the memory system 100 maybe one of the industry standard interfaces, or may be a purpose-designed interface.

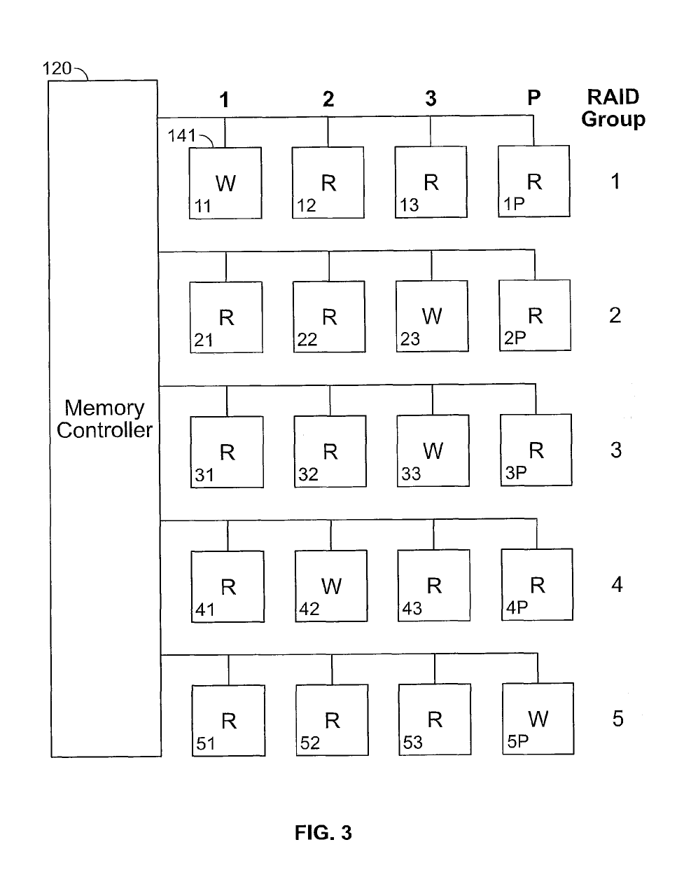

As shown in FIG. 3, the memory array 140 may be a plurality of memory units 141 communicating with the memory controller 120 using, for example, one or more bus connections. If the objective of the system design is to use low-cost SSD memory modules as the component modules 141 of the memory array 140, then the interface to the modules may be one which, at least presently, emulates a legacy hard disk, such as an ATA or a SATA protocol, or be a mini-PCIe card. Eventually, other protocols may evolve that may be better suited to the characteristics of FLASH memory.

Each of the FLASH memory modules 141₁₋ₙ may operate as an independent device. That is, as it was designed by the manufacturer to operate as an independent hard-disk-emulating device, the memory module may do so without regard for the specific operations being performed on any other of the memory devices 141 being accessed by the memory system controller 120.

Depending on the details of the design, the memory system 100 may serve to receive and service read requests from a “host” 10, through the interface 121 where, for example, the host-determined LBA of the requested data is transferred to the memory system 100 by device driver software in the host. Similarly, write requests may be serviced by accepting write commands to a host-determined LBA and an associated data payload from the host 10.

The memory system 100 can enter a busy state, for example, when the number of read and write requests fills an input buffer of the memory system 100. This state could exist when, for a period of time, the host is requesting data or writing data at a rate that exceeds the short or long term throughput capability of the memory system 100.

Alternatively, the memory system 100 may request that the host 10 provide groups of sequential read and write commands, and any associated data payloads in a quantity that fills an allocated memory space in a buffer memory 122 of the memory system 100.

Providing that the buffer memory 122 of the memory system 100 has a persistence sufficient for the contents thereof to be stored to a non-volatile medium in the case of power loss, the read and write commands and associated data may be acknowledged to the host as committed operations to upon receipt therefrom.

FIG. 3 is marked so as to allocate the memory modules 141 to various RAID groups of a RAIDed storage array, including the provision of a parity SSD module for each of the RAID groups. This is merely an illustrative example, and the number, location and designations of the SSDs 141 may differ in differing system designs. In an aspect, the memory system 100 may be configured so as to use dual parity or other higher order parity scheme. Operations that are being performed by the memory modules 141 at a particular epoch are indicated as read (R) or write (W). An erase operation (E) may also be performed.

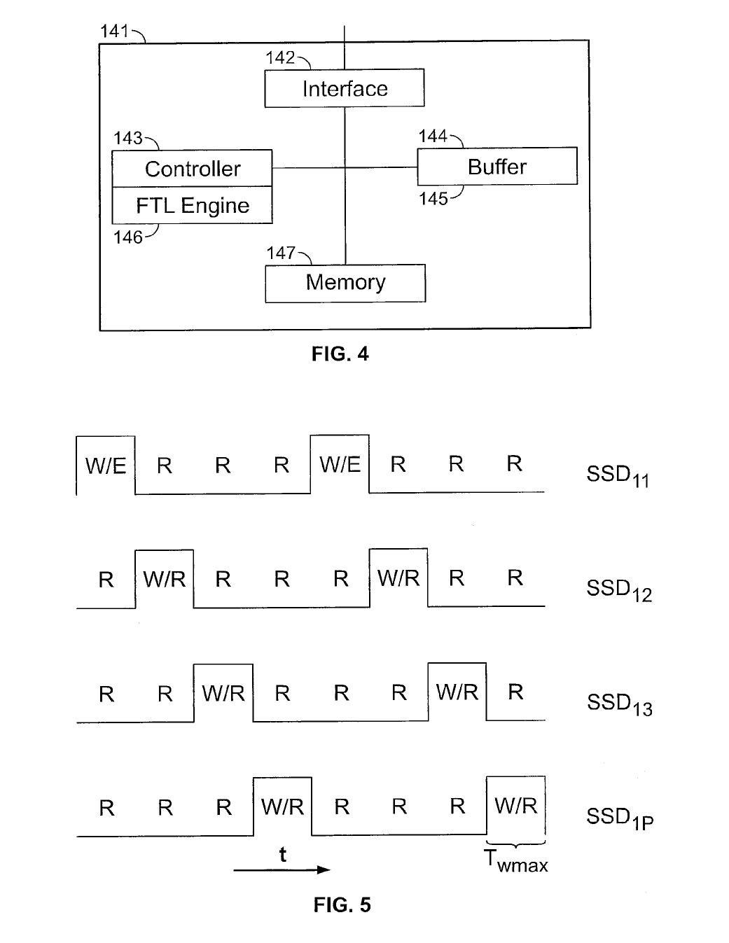

A typical memory module 141, shown in FIG. 4, may have an interface 142, compatible with the interface 125 of the memory controller 120 so as to receive commands, data and status information, and to output data and status information. In addition, the SSD module 141 may have a volatile memory 144, such as SRAM or DRAM for temporary storage of local data, and as a cache for data, commands and status information that may be transmitted to or received from the memory controller 125. A local controller 143 may manage the operation of the SSD 141, to perform the requested user initiated operations, housekeeping operations including metadata maintenance and the like, and may also include the FTL for managing the mapping of a logical block addresses (LBA) of the data space of the SSD 141 to the physical location (PBA) of data stored in the memory 147 thereof.

The read latency of the configuration of FIG. 3 may be improved if the SSD modules of a RAID group are operated such that only one of the SSD modules of each RAID group, where a strip of a RAID data stripe is stored, is performing other than a read operation at any time. If there are M data pages (strips) and a parity page (strip) in a stripe in a RAID group (a total of M+1 pages), M strips of the stripe of data (including parity data) from the M+1 pages stored in the stripe of the RAID group, will always be available for reading, even if one of the SSD modules is performing a garbage collection write or erase operation at the time that the read request is executed by the memory controller 124. FIG. 5 shows an example of sequential operation of 4 SSDs 141 comprising RAID group 1 of the memory array shown in FIG. 3. Each of the SSDs 141 has a time period during which write/erase/housekeeping (W/E) operations may be performed and another time period during which read (R) operations may be performed. As shown, the W/E operation periods of the 4 SSDs do not overlap in time.

As has been described in U.S. Pat. No. 8,200,887, “Memory Management System and Method,” issued on Jun. 12, 2012, which is commonly owned and which is incorporated herein by reference, any M of the M+1 pages of data and parity of a RAID group may, be used to recover the stored data. For example, if M1, M2 and M3 are available and Mp is not, the data itself has been recovered. If M1, M3 and Mp are available and M2 is not, the data may be reconstructed using the parity information, where M2 is the XOR of M1, M3 and Mp. Similarly, if either M1 or M3 is not available, but the remaining M pages are available, the late or missing data may be promptly obtained. This process may be termed “erase hiding” or “write hiding.” That is, the unavailability of any one of the data elements (strips) of a stripe does not preclude the prompt retrieval of stored data.

In an aspect, initiation of garbage collection operations by a SSD may be managed by writing, for example, a complete integral block size of data (e.g., 32 pages of 4 KB data initially aligned with a base address of a physical memory block, where the physical block size is 128 pages) of data each time that a data write operation is to be performed. This may be accomplished, for example, by accumulating write operations in a buffer memory 122 in the memory controller 120 until the amount of data to be written to each of the SSDs cumulates to the capacity of a physical block (the minimum unit of erasure). So, starting with a previously blank or erased PMB, the pages of data in the buffer 122 may be continuously and sequentially written to a SSD 141. By the end of the write operation, each of the PMAs in the PMB will have been written to and the PMB will be full. Depending on the specific algorithm adopted by the SSD manufacturer, completion of writing a complete PMB may trigger a garbage collection operation so as to provide a new “spare” block for further writes. In some SSD designs the garbage collection algorithm may wait until the next attempt to write to the SSD in order to perform garbage collection. For purposes of explanation, we assume that the filling of a complete PMB causes the initiation of a single garbage collection operation, if a garbage collection operation is needed so as to provide a new erased block for the erased block pool. Completion of the garbage collection operation places the garbage-collected block in a condition so as to be erased and treated as a “spare” or “erased” block.

Some FTL implementations logically amalgamate two or more physical blocks for garbage-collection management. In SSD devices having this characteristic, the control of the initiation of garbage collection operations is performed using the techniques described herein by considering the “block” to be an integral number of physical blocks in size. The number of pages in the “block” would be the same integral multiple of the pages of a block as the number of blocks in the “block”. Providing that the system is initialized so that the writing of data commences on a block boundary, and the number of write operations is controlled so as to fill a block completely, the initiation of garbage collection can similarly be controlled.

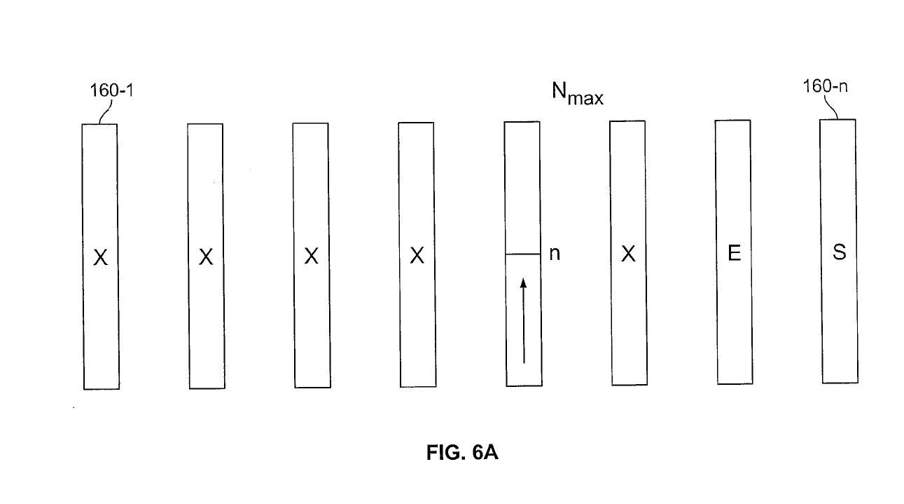

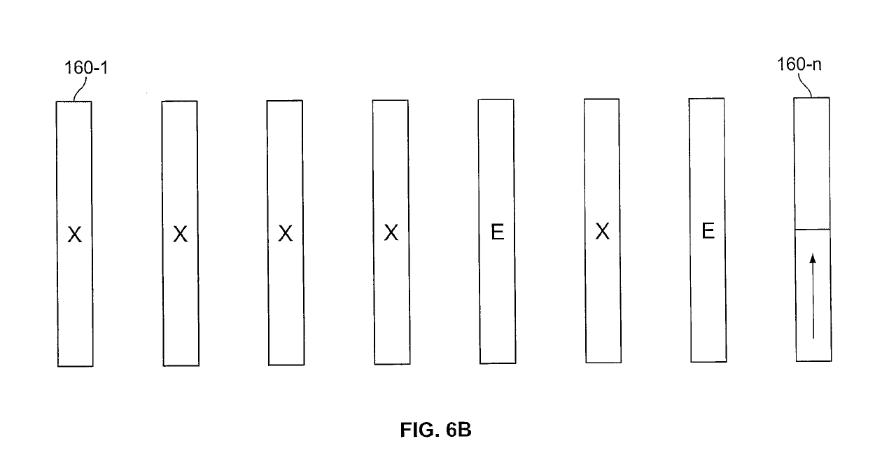

FIGS. 6A and 6B show successive states of physical blocks 160 of memory on a chip of a FLASH memory circuit 141. The state of the blocks is shown as: ready for garbage collecting (X), previously erased (E) and (S) spare. Valid data as well as invalid data may be stored in blocks marked X, and there may be free pages. When a PMB has been selected for garbage collection, the valid data remaining on the PMB is moved to another memory block having available PMPs and the source memory block may subsequently be erased. One of the blocks is in the process of being written to. This is shown by an arrow.

The block is shown as partially filled in FIG. 6A. At a later time, the block being filled in FIG. 6A will have become completely filled. That block, or another filled block selected using wear leveling criteria may be reclaimed as mentioned above and become an erased block. This is shown in FIG. 6B where the previously erased or spare block is now being written to. As may be seen, the physical memory blocks 160 may not be in an ordered arrangement in the physical memory, but the writing of data to a block 160 proceeds in a sequential manner within the block itself.

New, pending, write data may be accumulated in a buffer 122 in the memory controller 120. The data may be accumulated until the buffer 122 holds a number of LBAs to be written, and the total size of the LBAs is equal to that of an integral PMB in each of the SSDs of the RAID group. The data from the memory controller 120 is then written to each SSD of the RAID group such that a PMB filled exactly, and this may again trigger a garbage collection operation. The data being stored in the buffer may also include data that is being relocated for garbage collection reasons.

In an alternative, the write operations are queued in the buffer 122 in the memory controller 120. A counter is initialized so that the number of LBA pages that that have been written to a PMB is known (n<Nmax, where Nmax is the number of pages in a PMB). When an opportunity to write to the SSD occurs the data may be sequentially written to the SSD, and the counter n correspondingly incremented. At some point the value of the counter n equals the number of pages of data in the PMB that is being filled, n=Nmax. This filling would initiate a garbage collection operation. Whether the filling of the block occurs during a particular sequence of write operations depends on the amount of data that is awaiting writing, the value of the counter n at the beginning of the write period, and the length of the write period. The occurrence of a garbage collection operation may thus be managed.

In an illustrative example, let us consider that the memory controller 120 provides a buffer memory capability that has Nmax pages for each of the SSDs in the array, where Nmax is the number of pages in a PMB of each SSD. In a RAIDed system having M SSDs, let us say M=4; three of the SSDs would be used to store user data and the fourth SSD would be used to store the parity data for the user data. The parity data could be pre-computed at the time the data is stored in the buffer memory 121 of the memory controller 120, or can be computed at the time that the data is being read out of the buffer memory 121 so as to be stored in the SSDs.

For a typical flash device with ˜128 pages per block and a page program (write) time of ˜10 times a page read time, the SSD would be unavailable for reading during a garbage collection time during which ˜1,280 reads could be performed by each of the other SSDs 141 in the RAID group. Assuming that the time to erase a PMB is ˜5 times a page-write time (˜50 times a page-read time), a garbage collection an erase operation could take ˜1,330 typical page-read times. This time may reduced, as not all of the PMAs of the PMB being garbage collected may be valid data and invalid data need not be relocated. In an example, that perhaps half of the data in a block would be valid data, and an average garbage collection time for a block would be the equivalent of about 50+640=690 reads. The SSD would not be able to respond to a read request during this time.

Without loss of generality, one or more pages, up the maximum number of PMAs in a PMB can be organized by the controller and written the SSDs in a RAID group in a round robin fashion. Since the host computer 10 may be sending data to the memory controller 120 during the writing and garbage collection periods, additional buffering in the memory controller 120 may be needed.

The 4 SSDs comprising a RAID group may be operated in a round robin manner, as shown in FIG. 5. Starting with SSD1, a period for writing (or erasing) data Tw is defined. The time duration of this period may be variable, depending on the amount of data that is currently in the RAID 122 buffer to be written to the SSD, subject to a maximum time limit. During this writing time, the data is written to SSD11, but no data is written to SSDs 12, 13 or 14. Thus, data may be read from SSDs12, 13, 14 during the time that data is being written to SSD11, and the data already stored in SSD11 may be reconstructed from the data received from SSDs2-4, as described previously. This data is available promptly, as the read operations of SSDs 12, 13, 14 are not blocked by the write operations of SSD11. In the event that writing of data to SSD11 causes n to equal Nmax (the capacity of a PMB), the writing may continue to that point and terminate, and a garbage collection operation may initiate. SSD11 would continue to be unavailable (busy) for read operations until the completion of the garbage collection operation of SSD11. So, data may be written to SSD11 for the lesser of some maximum time (Twmax) or the time needed to fill the PMB currently being written to.

Either the write operation has proceeded for a period of time Twmax, or until n=Nmax and a garbage collection operation initiated and was allowed to complete before data can be written to SSD12 instead of SSD11. Completion of a garbage collection operation of SSD11 may be determined, for example,: (a) on a dead-reckoning basis (maximum garbage collection time); (b) by periodically issuing dummy reads or status checks to the SSD until a read operation can be performed; (c) waiting for the SSD on the bus to acknowledge completion of the write (existing consumer SSDs components may acknowledge writes when all associated tasks for the write (which includes associated reads) have been completed); or (d) any other status indicator that may be interpreted so as to indicate the completion of garbage collection. If a garbage collection operation is not initiated, the device becomes available for reading at the completion of a write operation, and writing to another SSD of the RAID group may commence.

When the token is passed to SSD12, the data stored in the buffer corresponding to the LBAs of the strip of RAID group written to SSD11 are now written to SSD12, until such time as the data has also been completely written. SSD12 should behave essentially the same as SSD11 as the corresponding PMB should have data associated with the same host LBAs as SSD11 and therefore have the same block-fill state. At this time, the token is passed to SSD13 and the process continues in a round-robin fashion. The round robin need not be sequential.

Round robin operation of the SSD modules 141 permits a read operation to be performed on any LBA of a RAID stripe without write or garbage collection blockage by the one SSD that is performing operations that render it busy for read operations.

The system may also be configured so as to service read requests from the memory controller 120 or a SSD cache for data that is available there, rather than performing the operation as a read to the actual stored page. In some cases the data has not as yet been stored. A read operation is requested for a LBA that is pending a write operation to the SSDs, the data is returned from the buffer 121 in the memory controller 120 used as a write cache, as this is the current data for the requested LBA. Similarly, a write request for an LBA pending commitment to the SSDs 141 may result in replacement of the invalid data with the new data, so as to avoid unnecessary writes. The write operations for an LBA would proceed to completion for all of the SSDs in the RAID group so as to maintain consistency of the data and its parity.

Operation of the SSD modules 141 of a RAID group as described above satisfies the conditions needed for performing “erase hiding” or “write hiding” as data from any three of the four FLASH modules 141 making up the RAID stripe of the memory array 140 are sufficient to recover the desired user data (That is, a minimum of 2 user data strips and one parity strip, or three user data strips). Hence, the latency time for reading may not be subject to large and somewhat unpredictable latency events which may occur if the SSD modules operated in an uncoordinated manner.

In an aspect, when read operations are not pending, write operations can be conducted to any of FLASH modules, providing that care is taken not to completely fill a block in the other FLASH modules during this time, and where the latency due to the execution of a single page write command is an acceptable performance compromise. The last PMA of a memory block in each SSD may be written to each SSD in turn in the round robin so that the much longer erase time and garbage collection time would not impact potential incoming read requests. This enables systems with little or no read activity, for even small periods of time to utilize the potential for high-bandwidth writes without substantially impacting user experienced read-latency performance.

This discussion has generally pertained to a group of 4 SSDs organized as a single RAID group. However FIG. 3 shows a RAIDed array where there are 5 RAID groups. Providing that the LBA activity is reasonably evenly distributed over the RAID groups, the total read or write bandwidths may be increased by approximately a factor of 5.

Taking a higher level view of the RAIDed memory system, the user may view the RAIDed memory system as a single “disk” drive having a capacity equal to the user memory space of the total of the SSDs 141, and the interface to the host 10 may be a SATA interface. Alternatively the RAIDed memory may be viewed as a flat memory space having a base address and a contiguous memory range and interfacing with the user over a PCIe interface. These are merely examples of possible interfaces and uses.

So, in an example, the user may consider that the RAIDed memory system is a logical unit (LUN) and the physical representation of the LUN is a device attached with a SATA interface. In such a circumstance, the user address (logical) is accepted by the memory controller 120 and buffered. The buffered data is de-queued and translated into a local LBA of the strip of the stripe on each of the disks comprising a RAID group (including parity). One of the SSDs of the RAID group is enabled for writing for a period of time Twmax, or until a counter indicates that data for a complete PMB of the SSD has been written to the SSD. If a complete PMB has been written, the SSD may autonomously initiate a garbage collection operation, during which time the response to the write of the last PMA of the PMB is typically delayed. When the garbage collection operation on the SSD has completed (which may include an erase operation) the write operation may complete and the SSD is again available for reading of data. Data of the second strip of the RAID stripe is now written to the second SSD. During this time data may be read from the first, third and fourth SSDs, so that any read operation may be performed and the data of the RAID stripe reconstructed as taught in U.S. Pat. No. 8,200,887. This process continues sequentially with the remaining SSDs of the RAID group.

Thus, conventional SSDs may have their operations effectively synchronized and sequenced so as to obviate latency spikes caused by the necessary garbage-collection operations or wear-leveling operations in NAND FLASH technology, or other memory technology having similar attributes. SSDs modules having legacy interfaces (such as SATA) and simple garbage collection schemas may be used in storage arrays and exhibit low read latency. In another aspect, the SSD controller of commercially available SSDs emulates a rotating disk, where the addressing is by cylinder and sector. Although subject to rotational and seek latencies, the hard disk has the property that each sector of the disk is individually addressable for reads and for writes, and sectors may be overwritten in place. But as this is inconsistent with the physical reality of the NAND FLASH memory, the flash translation layer (FTL) attempts to manage the writing to the FLASH memory so as to emulate the hard disk. As we have already described, this management often leads to long periods where the FLASH memory is unavailable for read operation, when it may be performing garbage collection.

Each SSD controller manufacturer deals with these issues in different ways, and the details of such controllers are usually considered to be proprietary information and not usually made available to purchasers of the controllers and FLASH memory, as the hard disk emulator interface is, in effect, the product being offered. However many of these controllers appear to manage the process by writing sequentially to a physical block of the FLASH memory. A certain number of blocks of the memory are logically made available to the user, while the FLASH memory device has an additional number of allocatable blocks for use in performing garbage collection and wear leveling. Other “hidden” blocks may be present and be used to replace blocks that wear out or have other failures. A “free block pool” is maintained from amongst the hidden and erased blocks.

Many FLASH memory devices used for consumer products for such applications as the storage of images and video enable only whole blocks to be written or modified. This enables the SSD controller to maintain a limited amount of state information (thus facilitating lower cost) as, in practice, the associated controller does not need to perform any garbage collection, or tracking of the validity of the data within a block. Only the index of the highest page number of the block that has been programmed (written) need be maintained if less than a block is permitted to be written. Entire objects, which may occupy one or more blocks are erased when the data is to be discarded.

When the user attempts to write to a logical block address of the SSD that is mapped to a physical block that already been filled, the data to be written is directed to a free block selected from the free block pool, and the data is written thereto. So, the logical block address of the modified (or new) data is re-mapped to a new physical block address. The entire page that has the old data is marked as being “invalid.” Ultimately number of free blocks in the free block pool falls to a value where a physical block or blocks having invalid data needs to be reclaimed by garbage collection. t

In an aspect, a higher level controller 120 may be configured to manage some of the process when more detailed management of the data is needed. In an example, the “garbage collection” process may divided into two steps: identifying and relocating valid data from a physical block to preserved when the block is erased, saving it elsewhere; and, the step of erasing the physical block that now has only invalid data. The process may be arranged so that the data relocation process is completed during the course of operation of the system as reads and writes, while the erase operation is the “garbage collection” step. Thus, while the reads and writes that may be needed to prepare a block can occur as single operations or burst operations, their timing can be managed by the controller 120 so as to avoid blockage of user read requests. The management of the relocation aspects of the garbage collection may be managed by a FTL that is a part of the RAID engine 123, so that the FTL engine 146 of the SSD 141 manages whole blocks rather than the individual pages of the data.

The SSD may be a module having form fit and function compatibility with existing hard disks and having a relatively sophisticated FTL, or the electronics may be available in less cumbersome packages. The electronic components that comprise the memory portion and electrical control and interface thereof, and a simple controller having a FTL with reduced functionality may be available in the form of one or more electronics package types such as ball grid array mounted devices, or the like, and a plurality of such SSD-electronic equivalent devices may be mounted to a printed circuit board so as to be more compact and less expensive non-volatile storage array.

Simple controllers are of the type that are ordinarily associated with FLASH memory products that are intended for use in storing bulk unstructured data such as is typical of recorded music, video, or digital photography. Large contiguous blocks of data are stored. Often a single data object such as a photograph or a frame of a movie is stored on each physical block of the memory, so that management of the memory is performed on the basis of blocks rather than individual pages or groups of pages. So, either the data in a block is valid data, or the data is invalid data that the user intends to discard.

The characteristic behavior of a simple flash SSD varies depending on the manufacturer and the specific part being discussed. For simplicity, the data written to the SSD may be grouped in clusters that are equal to the number of pages that will fill a single block (equivalent to the data object). If it is desired to write more data that will fill a single physical block, the data is presumed to be written in clusters having the same size as a memory block. Should the data currently being written not comprise an integral block, the integral blocks of data are written, and the remainder, which is less than a block of data is either written, with the number of pages written being noted, or the data is maintained in a buffer by the controller until a complete block of data is available to be written, depending on the controller design.

The RAID controller FTL has the responsibility for managing the actual correspondence between the user LBA and the storage location (local LBA at the SSD) in the memory module logical space,

By operating the memory controller 120 in the manner described, the time when a garbage collection (an erase operation for a simple controller) is being performed on the SSD is gaited, and read blockage may be obviated.

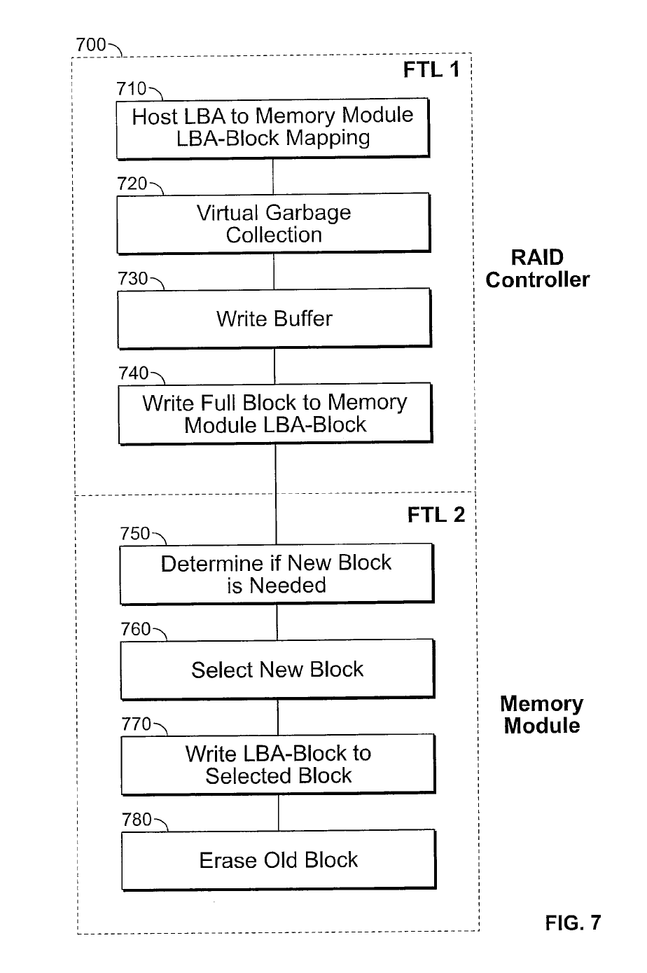

This process may be visualized using FIG. 7. When a request for a write to the memory system is executed by the memory controller 120, the LBA of the write request is interpreted by the FTL1 to determine if the LBA has existing data that is to be modified. If there is no data at the LBA, then the FTL1 may assign the user LBA to a memory module local LBA corresponding to the one in which data is being collected in the buffer 122 for eventual writing as a complete block (step 710). This assignment is recorded in the equivalent of a L2P table, except that at this level, the assignment is to another logical address (of the logical address space of the memory module), so we will call the table an L2L table.

Where the host LBA request corresponds to a LBA where data is already written, a form of virtual garbage collection is performed. This may be done by marking the corresponding memory system LBA as invalid in the L2L table. The modified data of the LBA the mapped to a different available local LBA in the SSD, which falls into the block of data being assembled for writing to the SSD. This is a part of the virtual garbage collection process (step 720). The newly mapped data is accumulated in the buffer memory 122 (step 730).

When a complete block of data equal to the size of a SSD memory module block is accumulated in the buffer, the data is written to the SSD. At the SSD, the FTL2 receives this data and determines, through the L2P table, that there is data in that block that is being overwritten (step 750). Depending on the specific algorithm, the FTL2 may simply erase the block and write the new block of data in place. Often, however, the FTL2 invokes a wear leveling process and selects an erased block from a free block pool, and assigns the new physical block to the block of logical addresses of the new data (step 760). This assignment is maintained in the L2P table of FTL2. When the assignment has been made, the entire block of data can be written to the memory module 141 (step 770). The wear leveling process of FTL2 may erase a block of the blocks that have been identified as being available for erase. For example, the physical block that was pointed to as the last physical block that had been logically overwritten. (step 780).

In effect, FTL1 manages the data at a page size level, LBA by LBA, and FTL2 manages groups of LBAs of a strip having a size equal to that of a physical block of the SSD. This permits the coordination of the activities of a plurality of memory circuits 141 as the RAID controller determines the time at which data is written to the memory circuits 141, the time that when a block would become filled, and the expected occurrence of an erase operation.

In an aspect, the data being received from a host 10 for storage may be accumulated in a separate data area from that being stored as data being relocated as part of the garbage collection process. Alternatively, data being relocated as part of the garbage collection process may be intermixed with data that is newly created or newly modified by the host 10. Both of these are valid data of the host 10. However, a strategy of maintaining a separate buffer area allocation for data being relocated may result in large blocks of newly written or modified data from the host 10 being written in sequential locations in a block of the memory modules. Existing data that is being relocated in preparation for an erase operation may be data that has not been modified in a considerable period of time, as the data that may be in the process of being relocated from the block that meets the criteria of not having been erased as frequently as other blocks, or that has more of the pages of the block being marked as being invalid. So, blocks that have become sparsely populated with valid data due to the data having been modified will be consolidated, and blocks that have not been accessed in a considerable period of time will be refreshed.

Refreshing of the data in a FLASH memory may be desirable so as to mitigate the eventual increase in error rate for data that has been stored for a long time. The phrase “long time” will be understood by a person of skill in the art as representing an indeterminate period, typically between days and years, depending of the specific memory module part type, the number of previous erase cycles, the temperature history, and the like.

The preceding discussion focused on one of the SSDs of the RAID group. But, since the remaining strips of the RAID group stripe are related to the data in the first column by a logical address offset, the invalid pages, the mapping and the selection of blocks to be made available for erase, may be performed by offsets from the L2P tables described above. The offsets may be the indexing of the SSDs in the memory array. The filling of the block in each column of the RAID group would be permitted to occur in some sequence so that erases for garbage collection are also sequenced. As the memory controller 120 keeps track of the filling of each block in the SSD, as previously described, the time when a block becomes filled, and another block in the SSD is erased for garbage collection is controlled.

In another example, the memory system may comprise a plurality of memory modules MM0-MM4. A data page (e.g., 4 KB) received from the host 110 by the raid controller is segmented into four equal segments (1 KB each), and a parity computed over the four segments. The four segments and the parity segment may be considered strips of a RAID stripe. The strips of the RAID stripe are intended to be written to separate memory modules of the MM0-MM4 memory modules that comprise the RAID group.

At the interface between the SSD 141 and the memory controller 120, the memory space available to the user may be represented, for example, as a plurality of logical blocks having a size equal to that of one or more physical blocks of memory in the memory module. The number of physical blocks of memory that are used for a logical block may be equal to a single physical block size or a plurality of physical blocks that are treated as a group for management purposes. The physical blocks of a chip that may be amalgamated to form a logical block may not be sequential; however, this is not known by the user.

The memory controller 120 may receive a user data page of 4 KB in size and allocated 1 KB of this page to a page of each of the SSDs in the RAID group to form a strip. Three more user data pages may be allocated to the page to form a 4 KB page in the SSD logical space. Alternatively the number of pages of data equal to the physical block size of the SSD may be accumulated in the buffer 121.

The previous example described decomposing a 4 KB user data page into four 1 KB strips for storage. The actual size of the data that is stored using a write command may vary depending on the manufacturer and protocol that is used. Where the actual storage page size is 4 KB, for example, the strips for a first 1 K portion of 4 user pages may be combined to form a data page for writing to a page of a memory module.

In this example, a quantity of data is buffered that is equal to the logical storage size of the logical page, so that when data is written to a chip, an entire logical page may be written at one time. The same number of pages is written to each of the memory modules, as each of the memory modules in a RAID stripe contains either a strip of data or the parity for the data.

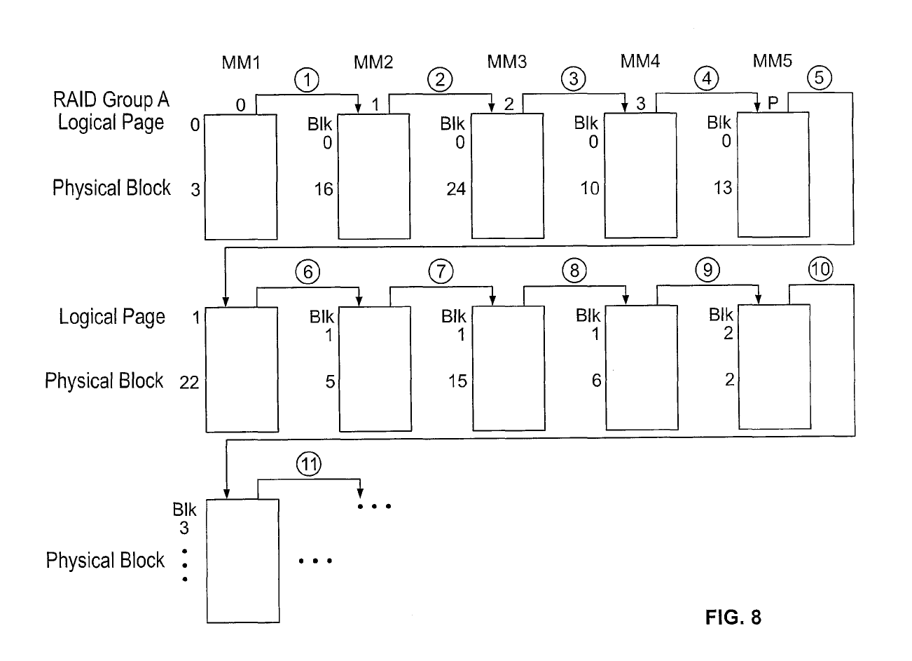

The sequence of writing operations in FIG. 8 is shown by numbers in circles in the drawings and by [#] in the text. Writing of the data may start on any memory module of the group of memory modules MM (a SSD) of a RAID stripe so long as all of the memory modules of the RAID stripe are written to before a memory module is written to a second time. Here, we show the process proceeding in a linear fashion.

When sufficient data has been accumulated so as to be able to write logical blocks of a size equal to the physical block size, the writing process starts. The data of the first strip may be written to MM1, such that all of the data for the first strip of the RAID stripe for all of the pages in the physical block is written to MM1. Next, the writing proceeds [1] to MM2, and all of the data for the second strip of the RAID stripe for all of the pages in the physical block is written to MM2, and so forth [M2, M3, M4] until the parity data is written is written to MM5, thus completing the commitment of all of the data for the logical block of data to the non-volatile memory. In this example, local logical block 0 of each of the MMs was used, but the physical block in MM1, for example is 3 as selected by the local FTL.

When a second logical block of data has been accumulated, the new page of data is written [steps 5-9] to another set of memory blocks (in this case local logical block 1) comprising the physical blocks (22, 5, 15, 6, 2) assigned to the RAID group in the MM.

The sequence of operations described in this example is such that only one strip of the RAID stripe is being written to at any one time. So, data on other physical blocks of the RAID group on a memory module, for the modules that are not the one that is being written to at the time, may be read without delay, and the user data recovered as being either the data of the stripes of the user data, or less than all of the data of the user data strips and including sufficient parity data to reconstruct the user data.

Where the logical block and the physical block are aligned, an erase operation may occur at either the beginning or the end of the sequence of writes for the entire logical block. So, depending on the detailed design choices made for the chip controller, there may be an erase operation occurring, for example, at the end of step [1] where the writing is transferred from MM 1 to MM2, or at the beginning of step [2] where the writing is transferred from MM2 to MM3.

Often the protocol used to write to FLASH memory is derived from legacy system interface specifications such as ATA and its variants and successors. A write operation is requested and the data to be written to a logical address is sent to the device. The requesting device waits until the memory device acknowledges receipt of a response indicating commitment of the data to a non-volatile memory location before issuing another write request. So, typically, a write request would be acknowledged with a time delay approximating the time to write the strip to the FLASH memory. In a situation where housekeeping operations of the memory controller are being performed, the write acknowledgment would be delayed until completion of the housekeeping operation and any pending write request.

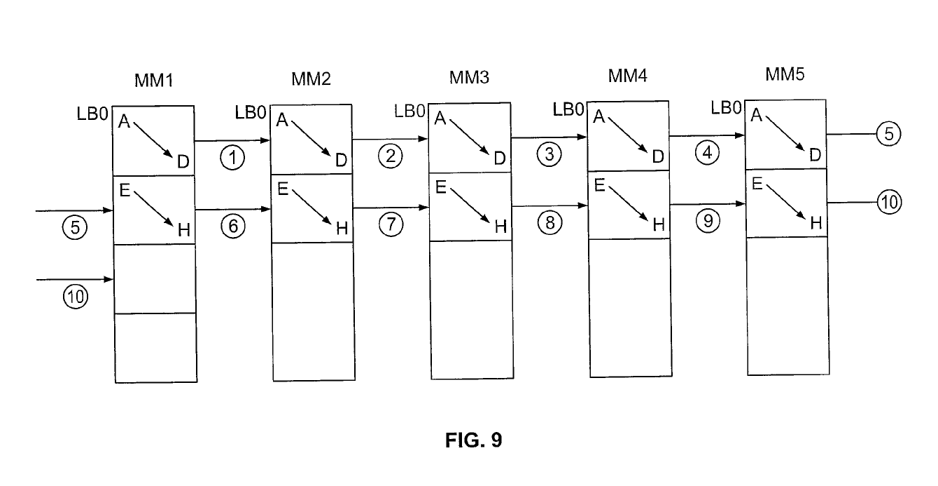

The method of FIG. 8 illustrated an example where a full logical page of data was written sequentially to each of the memory modules. FIG. 9 illustrates a similar method where a number of user data pages that is less than the size of a full physical block may be written to the memory modules. The control of the sequencing is analogous to that of FIG. 5, except that a number of pages K that is less than the number of pages Nmax that can be stored in the logical block are written to a memory module, and then the writing activity is passed to another memory module 141 of the RAID group. Again, all of the strips of the RAID group are written to so as to store all of the user data and the parity data for that data.

By writing a quantity of pages K that is less than N, the amount of data that needs to be stored in a buffer 122 may be reduced. The quantity of pages K that are stored may be a variable quantity for any set of pages, providing that all of the memory modules 141 store the same quantity of strips and the data and the parity for the data is committed to non-volatile storage before another set of data is written to the blocks.

The data that is stored in the buffer memory 122 may be metadata for FTL1, user data, housekeeping data, data being relocated for garbage collection, memory refresh, wear leveling operations, or the like. FTL1 at the RAID controller level manages the assignment of the user logical block address to the memory device local logical block address. In this manner, as previously described, the flash memory device 141 and its memory controller 143 and FTL2 may treat the management of free blocks and wear leveling on a physical block level (e.g., 128 pages), with lower-level management functions (page-by page) performed elsewhere, such as by FTL 1.

The buffer memory 122, at the memory controller level may also be used as a cache memory. While the data to be written is held in the cache prior to being written to the non-volatile memory, a read request for the data may be serviced from the cache, as that data is the most current value of the data. A write request to a user LBA that is in the cache may also be serviced, but the process will differ whether the data of LBA data stripe is in the process of being written to the non-volatile memory. Once the process of writing the data of the LBA stripe to the non-volatile memory has begun for a particular LBA (as in FIG. 8 or 9), that particular LBA, which has an associated computed parity needs to be completely stored in the non-volatile memory so as to ensure data coherence. So, once a cached LBA is marked so as to indicate that it is being, or has been, written to the memory, the new write request to the LBA is treated as a write request to a stored data LBA location and placed in the buffer for execution. However, a write request to an LBA that is in the buffer, but has not as yet begun to be written to the non-volatile memory may be effected by replacing the data in the buffer for that LBA with the new data. This new data will be the most current user data and there would have been no reason to write the invalid data to the volatile memory.

When an array of SSDs is operated in a RAID configuration with a conventional RAID controller, the occurrence of the latency duration spikes associated with housekeeping operations is seen by the user as an occasional large delay in the response to a read request. This sporadic delay is known to be a significant factor in reducing system performance, and the control of memory modules in the examples described above is intended to obviate the problem by erase/write hiding in various configurations.

A system using conventional SSDs may be operated in a similar manner to that described, providing that the initiation of housekeeping operations is prompted by some aspect of write operations to the module. That is, when writing to a first SSD, the status of the SSD is determined, for example, by waiting for a confirmation of the write operation. Until the first SSD is in a state where read operations are not inhibited, data may not be written to the other SSDs of a RAID group as outlined above. So, if a read operation is performed to the RAID group, sufficient data or less than all of the data but sufficient parity data is available to immediately report the desired data. The time duration during which a specific SSD is unavailable would not be deterministic, but by using the status of the SSD to determine which disk can be written to, a form of write/erase hiding can be obtained. Once the relationship of the number of LBAs written to the SSD to the time of performing erase operations is established for all of the SSDs in the RAID stripe, the array of SSDs may be managed as previously described.

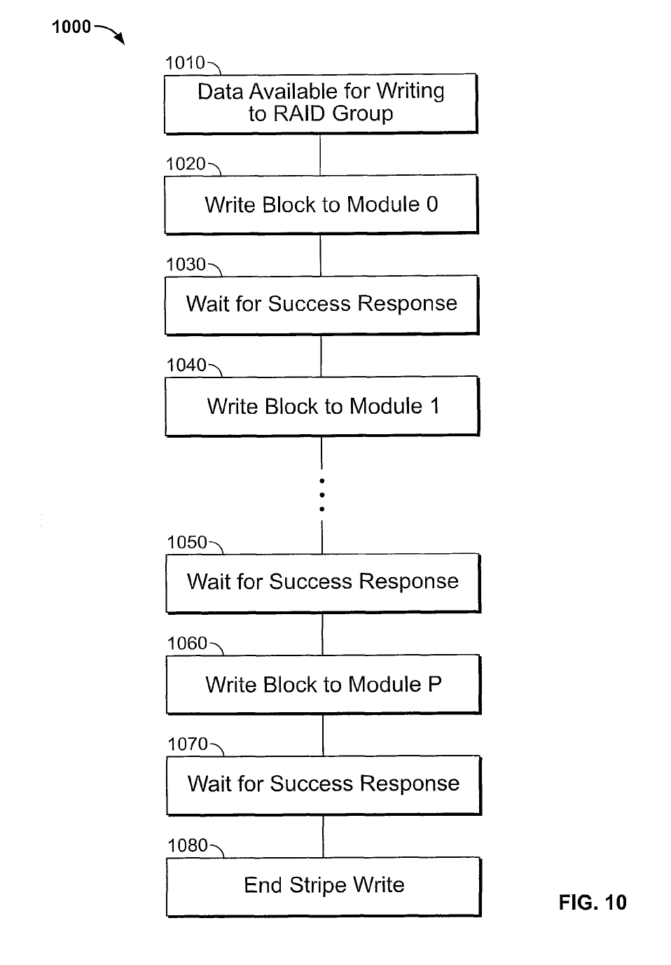

FIG. 10 is a flow chart illustrating the use of this SSD behavior to manage the operation of a RAIDed memory to provide for erase (and write) hiding. The method 1000 comprises determining if sufficient data is available in the buffer memory to be able to write a full physical block of data to the RAID group (step 1010). A block of data is written to the SSD that is storing the “0” strip of the RAID stripe (step 1020). The controller waits until the SSD “0” reports successful completion of the write operation (step 1030). This time can include the writing of the data, and whatever housekeeping operations are needed, such as erasure of a block. During the time when the writing to SSD “0” is being performed, data is not written to any other SSD of the RAID group. Thus, a read operation to the RAID group will be able to retrieve data from SSDs “1”-“P”, which is sufficient data to reconstruct the data that has been stored. Since this data is available without blockage due to a write or erase operation, there is no write or erase induced latency in responding to the user requests.

Once the successful completion of the block write to SSD “0” has been received by the controller, the data for SSD “1” is written (step 1040), and so on until the parity data is written to SSD “P” (step 1070). The process 1000 may be performed whenever there is sufficient data in a buffer to write a RAID group, or the process may be performed incrementally. If a erase operation is not performed, then the operation will have completed faster.

This method of regulating the operation of writing a RAID stripe adapts to the speed with which the SSDs operate in performing the functions needed, and may not need an understanding of the operations of the individual SSDs, except perhaps at initialization or during an error recovery. The start of a block may be determined by stimulating the SSD by a sequence of page writes until such time as an erase operation is observed to occur as manifest by the long latency of an erase as compared with a write operation. Subsequently, the operations may be regulated on a block basis.

Where the term SSD is used, there is no intent to restrict the device to one that conforms to an existing form factor, industry standard, hardware or software protocol, or the like. Equally, a plurality of such SSDs or memory modules may be assembled to a system module which may be a printed circuit board, or the like, and may be a multichip module or other package that is convenient. The scale sizes of these assemblies are likely to evolve as the technology evolves, and nothing herein is intended to limit such evolution.

It will be appreciated that the methods described and the apparatus shown in the figures may be configured or embodied in machine-executable instructions, e.g. software, or in hardware, or in a combination of both. The machine-executable instructions can be used to cause a general-purpose computer, a special-purpose processor, such as a DSP or array processor, or the like, that acts on the instructions to perform functions described herein. Alternatively, the operations might be performed by specific hardware components that may have hardwired logic or firmware instructions for performing the operations described, or by any combination of programmed computer components and custom hardware components, which may include analog circuits.

The methods may be provided, at least in part, as a computer program product that may include a non-volatile machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions or data for execution by a computing machine or special-purpose hardware and that may cause the machine or special purpose hardware to perform any one of the methodologies or functions of the present invention. The term “machine-readable medium” shall accordingly be taken include, but not be limited to, solid-state memories, optical and magnetic disks, magnetic memories, and optical memories, as well as any equivalent device that may be developed for such purpose.

For example, but not by way of limitation, a machine readable medium may include read-only memory (ROM); random access memory (RAM) of all types (e.g., S-RAM, D-RAM. P-RAM); programmable read only memory (PROM); electronically alterable read only memory (EPROM); magnetic random access memory; magnetic disk storage media; flash memory, which may be NAND or NOR configured; memory resistors; or electrical, optical, acoustical data storage medium, or the like. A volatile memory device such as DRAM may be used to store the computer program product provided that the volatile memory device is part of a system having a power supply, and the power supply or a battery provides power to the circuit for the time period during which the computer program product is stored on the volatile memory device.

Furthermore, it is common in the art to speak of software, in one form or another (e.g., program, procedure, process, application, module, algorithm or logic), as taking an action or causing a result. Such expressions are merely a convenient way of saying that execution of the instructions of the software by a computer or equivalent device causes the processor of the computer or the equivalent device to perform an action or a produce a result, as is well known by persons skilled in the art.

Although only a few exemplary embodiments of this invention have been described in detail above, those skilled in the art will readily appreciate that many modifications are possible in the exemplary embodiments without materially departing from the novel teachings and advantages of the invention. Accordingly, all such modifications are intended to be included within the scope of this invention.

What is claimed is:

1. A data storage system, comprising:
a plurality of memory modules, each memory module having:
a plurality of memory blocks,
a first controller configured to execute a mapping between a logical address of data received from a second controller and a physical address of a selected memory block; and
the second controller configured to interface with the groups of memory modules of the plurality of memory modules, each group comprising a RAID group,
wherein the second controller is further configured execute a mapping between a logical address of user data and a logical address of each of each of the memory modules of the group of memory modules of the RAID such that user data is written to the selected memory block of each memory module.

2. The system of claim 1, wherein the data is written to the group of memory modules of the RAID group one page at a time.

3. The system of claim 1, wherein the data is written to the group of memory modules of the RAID group such that the number of pages of data written at one time is less than or equal to the number of pages of the selected memory block.

4. The system of claim 1, wherein the data is written to the group of memory modules of the RAID group such that the number of pages of data written at one time is equal to the number of pages of the memory block.

5. The system of claim 1, wherein a quantity of data written to a memory module of the RAID group fills a partially filled memory block.

6. The system of claim 1, wherein the first controller interprets a write operation to a previously written logical memory of the memory module location as an indication that the physical memory block that is currently mapped to logical memory location may be erased.

7. The system of claim 1, wherein the memory module reports a busy status when performing a write or an erase operation.

8. The system of claim 7, wherein a write operation to another memory module of the RAID group is inhibited until the memory module last written to does not report a busy status.

9. The system of claim 1, wherein the status of a module being written to is determined by polling the module.

10. The system of claim 1, wherein the status of a module being written to is determined by the response to a test message.

11. The system of claim 10, wherein the test message is a read request.

12. A method of storing data the method comprising:
providing a memory system having a plurality of memory modules;
selecting a group of memory modules of the group of memory modules to comprise a RAID group; and
providing a RAID controller;
receiving data from a user and processing the data for storage in the RAID group by:
mapping a logical block address of a received page of user data to a logical address space of each of the memory modules of a RAID group;
selecting a block of memory of each of the memory modules that has previously been erased;
mapping the logical address space of each of the memory modules to a physical address space in the selected block of the memory module;
writing the mapped data to the selected block of each memory module until the block is filled before mapping data to another memory block of each memory module of the RAID group.

13. The method of claim 12, wherein the block is filled by writing a quantity of data that is less than the data capacity of the block a plurality of times.

14. The method of claim 13, wherein a same number of pages is written to each of the mapped blocks a first time, prior to any mapped block being written to a second time.

15. The method of claim 12, wherein when the number of pages written to each of the mapped blocks is equal to a maximum number of pages of a block, another block is for mapping.

16. A computer program product stored on a non-transient computer readable medium comprises instructions to cause a controller to:
select a group of memory modules comprising a RAID group receive data from a user and process the data for storage in the RAID group by:
mapping a logical block address of a received page of user data to a logical address space of each of the memory modules of the RAID group;
selecting a block of memory of each of the memory modules that has previously been erased;
mapping the logical address space of each of the memory modules to a physical address space in the selected block of the memory module;
writing the mapped data to the selected block of each of the memory modules until the block is filled before mapping data to another memory block of each of the memory modules of the RAID group.
